(19) United States
(12) Patent Application Publication
(10) Pub. No.: US 2004/0046716 A1
(43) Pub. Date: Mar. 11, 2004

(54) Method for displaying video images on a plasma display panel and corresponding plasma display panel

(76) Inventors: Bertrand Chupeau, Rennes (FR); Didier Doyen, La Bouexiere (FR); Jonathan Kervec, Le Patis Josset (FR)

Correspondence Address: Joseph S Tripoli, Thomson Multimedia Licensing Inc, Patent Operations CN 5312, Princeton, NJ, 08543-0028, US

(21) Appl. No.: 10/470,563

(22) PCT Filed: Jan. 18, 2002
(86) PCT No.: PCT/FR02/00195

(51) Int. Cl. G09G 3/28

(52) U.S. Cl. 345/60

(57) ABSTRACT

The invention concerns a method for displaying video images on a plasma display panel. The invention is particularly applicable in plasma display panels comprising a matrix of elementary cells which can be either lighted or unlighted. The invention is characterized in that in order to provide motion compensation of irregular contours, the method consists in defining in the temporal integration window a reference time and in moving the underscans of the temporal integration window relative to said reference time. The underscans consecutive to the time reference in the temporal integration window are moved in the motion direction and the other underscans are moved in the opposite direction.

The present invention relates to a method of displaying video images on a plasma display panel. The invention applies more particularly to plasma display panels (PDPs) comprising a matrix of elementary cells that may be either in the on state or in the off state.

The technology of PDPs allows large flat display screens to be obtained. PDPs generally comprise two insulating plates defining between them a gas-filled space in which elementary spaces bounded by barrier ribs are defined. Each plate is provided with one or more arrays of electrodes. An elementary cell corresponds to an elementary space provided on each side of the said elementary space with at least one electrode. To activate an elementary cell, an electrical discharge is produced in the corresponding elementary space by applying a voltage between the electrodes of the cell. The electrical discharge then causes the emission of UV rays in the elementary cell. Phosphors deposited on the walls of the cell convert the UV rays into visible light.

The operating period of an elementary cell of a PDP corresponds to the display period of a video image. Each display period is composed of elementary periods commonly called subfields. Each subfield comprises a cell address period and a sustain period. The address period consists in sending or not sending an electrical pulse into the elementary cell depending on whether it has to be placed in the on state or the off state. The sustain period consists in sending a succession of pulses for a given time in order to keep the cell in the on state or the off state. Each subfield has a specific sustain period duration. The sustain periods are distributed over the entire display period and correspond to illumination periods of the cell. The human eye then performs an integration of these illumination periods in order to recreate the corresponding grey level. The display period of an image is called the temporal integration window in the rest of the description.

There are a few problems associated with the temporal integration of the illumination periods. A false contouring problem occurs especially when an object moves between two consecutive images. This problem is manifested by the appearance of darker or lighter bands at grey level transitions which are normally barely perceptible. In the case of colour PDPs, these bands may be coloured.

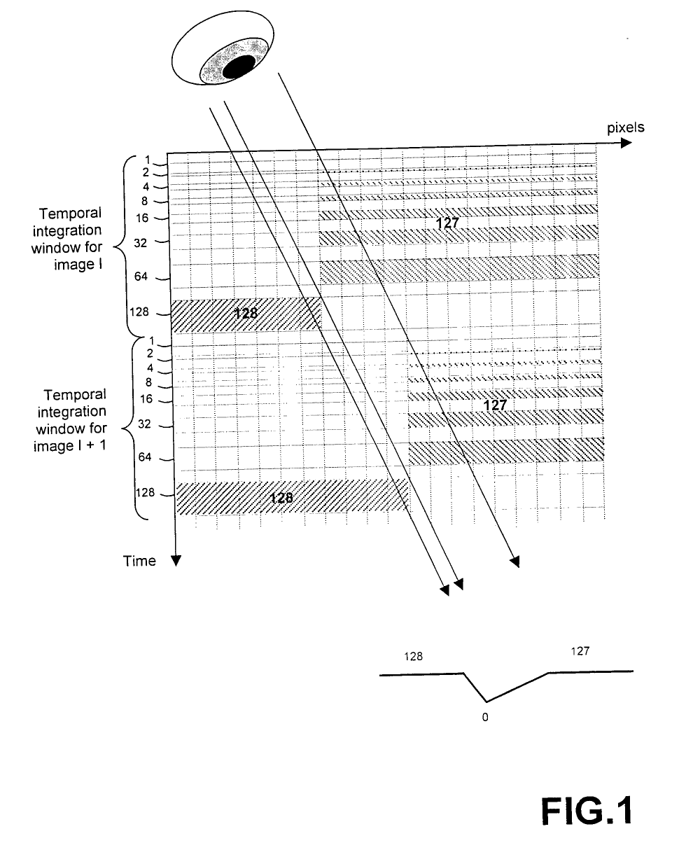

This false contouring problem is illustrated by FIG. 1 which shows the subfields for two consecutive images, I and I+1. FIG. 1 corresponds to a worst-case scenario having a transition between a grey level 127 and a grey level 128. This transition is displaced by 4 pixels between the image I and the image I+1. In this figure, the Y-axis represents the time axis and the X-axis represents the pixels of the various images. The integration performed by the eye amounts to integrating over time along the oblique lines shown in the figure, since the eye has a tendency to follow the moving object. It therefore integrates the information coming from different pixels. The result of the integration is manifested by the appearance of a grey level equal to zero at the moment of the transition between the grey levels 127 and 128. This passage through the zero grey level makes a dark band appear at the transition. Conversely, if the transition passes from the level 128 to the level 127, a level 255 corresponding to a light band appears at the moment of the transition.

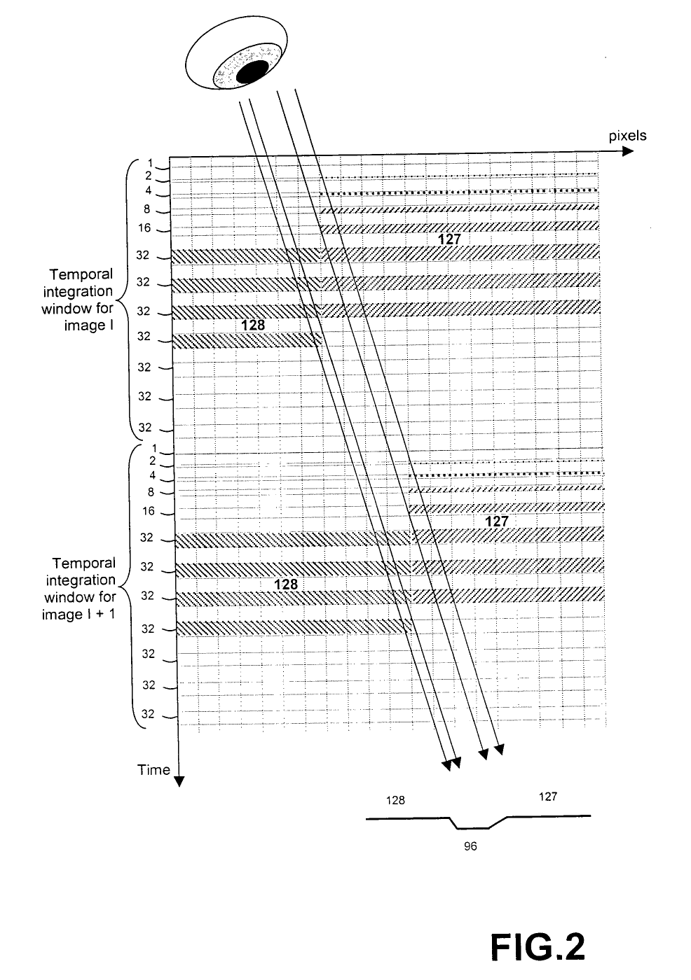

A first solution consists in “breaking” the high-weight subfields in order to reduce the integration error. FIG. 2 shows the same transition as FIG. 1, but with seven subfields of weight 32 instead of the three subfields of weight 32, 64 and 128. The maximum integration error then has a grey level value of 32. It is also possible to distribute the grey levels differently, but there is always an integration error.

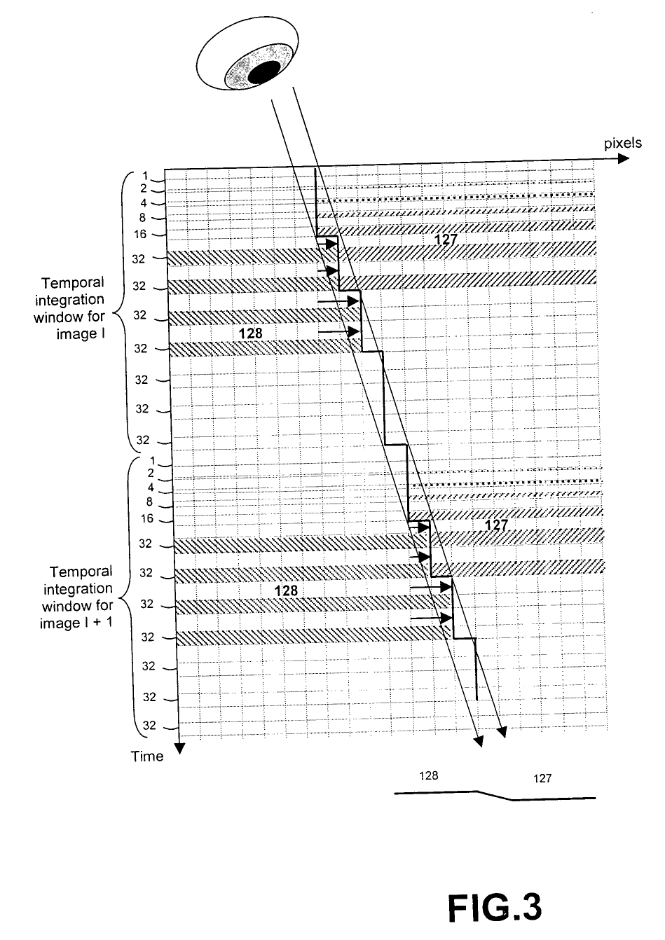

Another solution to this problem, given in European Patent Application No. 0 978 817, consists in anticipating this integration by the eye by shifting the subfields in the direction of movement so that the eye integrates the correct information. This technique uses a movement estimator to calculate a movement vector for each pixel of the image to be displayed. These movement vectors are used to modify the data delivered to the elementary cells of the PDP. The basic idea of Patent Application 0 978 817 is to detect the eye's movements during the display of the images and to deliver to the cells movement-compensated data so that the eye integrates the correct information. This technique is illustrated in FIG. 3. As mentioned previously, this correction consists in spatially displacing the subfields according to the observed movements between the images so as to anticipate the integration that the human eye will perform. The subfields are displaced differently according to their temporal position in the temporal integration window. This correction gives excellent results on the transitions which cause false contouring effects.

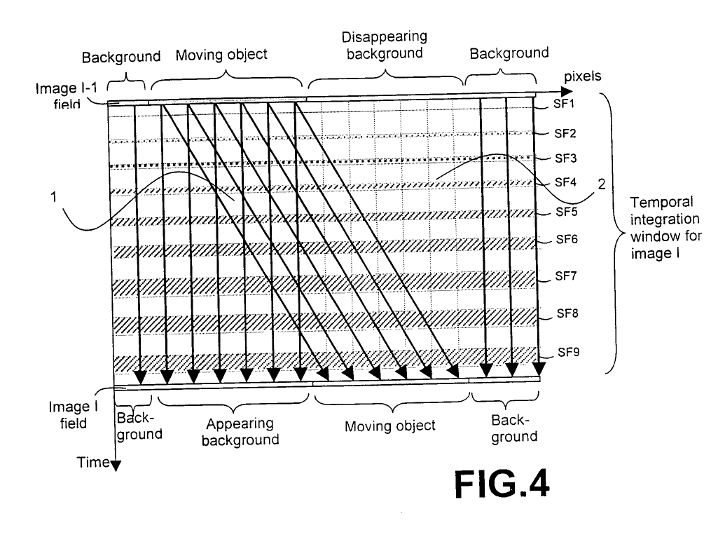

However, this correction has a few drawbacks when objects appear or disappear between two images. FIG. 4 shows vectors representative of the movement between an image I−1 and an image I that are calculated with a movement estimator of the prior art. A movement vector is calculated for each pixel of the image I. Each movement vector normally has a horizontal component and a vertical component corresponding to the horizontal and vertical displacement of a point between the two images. For clarity of representation reasons, the image has been shown, as previously, only over one spatial dimension by the horizontal axis in the figure, the vertical axis representing time. In this figure, the image I is displayed by means of nine subfields, denoted SF1 to SF9, placed in the increasing order of their weights. The sustain periods of the subfields are hatched whatever the state—on or off—of the cells for this subfield. Each movement vector defines the direction, the sense and the amplitude of the movement of a pixel between the image I−1 and the image I. However, it should be noted that, since the image I is shown only along one spatial dimension, it is not possible to represent the direction of the movement vectors but only their sense and their amplitude along the spatial axis chosen.

According to the technique developed in European Patent Application No. 0 978 817, the subfields of the image I are displaced in the direction of the movement vectors, the amplitude of the displacement of a subfield depending on its temporal position in the temporal integration window. The subfields of a pixel of the image I are displaced in the reverse sense of the movement vector in question, since the movement vector associated with the pixel of the image I is representative of the movement between the image I−1 and the image I.

This example considers the case of an object moving past a background between the image I−1 and the image I. Part of the background of the image I−1 disappears into the image I, while a new part of the background appears in the image I. A region of conflicts 1 and a region of holes 2 then appear. These two regions are represented by hatched regions in FIG. 4. The region of conflicts1 is characterized by the intersection of two movement vectors imposing two different displacements on the subfield in question for a given pixel in this region. The region of holes 2 is characterized by the absence of information for the subfields of this region.

Methods exist for determining the movement vectors to be used in these regions of holes and conflicts. However, these methods require a computing power proportional to the number of holes and conflicts to be corrected.

It is therefore an object of the invention to reduce the size of these regions of holes and conflicts.

Thus, the invention relates to a method of displaying video images on a plasma display panel comprising a plurality of elementary cells, in which the grey levels are obtained by temporal integration over a period called the temporal integration window comprising a plurality of subfields during which each elementary cell of the said plasma display panel is either in the on state or in the off state, characterized in that it comprises the following steps:

for each video image to be displayed, the movement of the said video image to be displayed with respect to the previous video image is estimated so as to generate a movement vector for each pixel of the video image to be displayed;

a reference instant placed within the temporal integration window is defined;

for each pixel of the video image to be displayed, the subfields are displaced with respect to the reference instant so that the shift between the first subfield and the last subfield is approximately equal to the amplitude of the associated movement vector, the amplitude of the displacement of each subfield depending on its temporal position with respect to the reference instant in the temporal integration window and on the direction of the associated movement vector.

This method makes it possible to reduce the maximum amplitude of displacement of the subfields and thereby reduce the number of holes and conflicts in the temporal integration window.

Preferably, a reference subfield coincides with the reference instant, the reference subfield being different from the first subfield or the last subfield of the said plurality of subfields. Thus, the reference subfield is not displaced. The other subfields are displaced either in the sense of the associated movement vector, or in the opposite sense. This avoids displacement calculations for a subfield. Advantageously, the reference subfield is close to the middle of the temporal integration window.

The invention also relates to a plasma display panel, characterized in that it includes a device that implements the video image display method of the invention.

Other features and advantages of the invention will become apparent on reading the following detailed description given with reference to the appended drawings, among which:

FIG. 1 illustrates the false contouring effects that occur when a transition moves between two consecutive images;

FIGS. 2 and 3 illustrate known solutions for compensating for these false contouring effects;

FIG. 4 shows an example of a movement field delivered by a movement estimator;

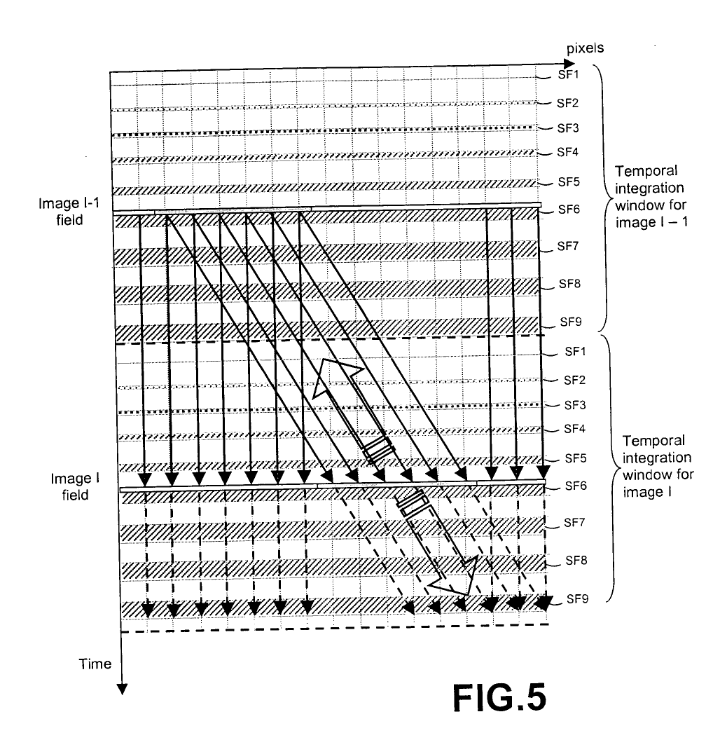

FIG. 5 illustrates the method of the invention; and

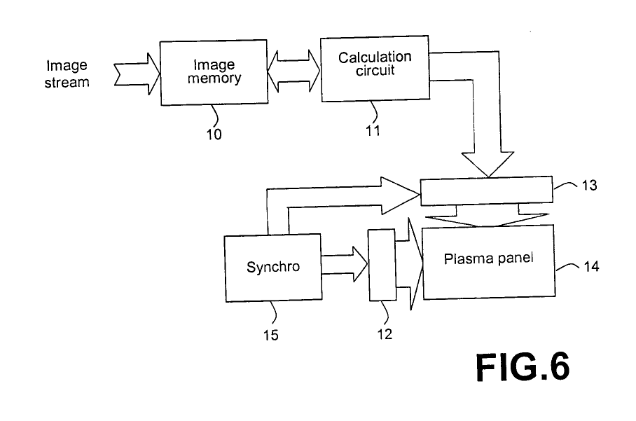

FIG. 6 shows an example of a device allowing the method of the invention to be implemented.

FIGS. 1 to 4, already described in the preamble of the present description, will not be explained in further detail.

Hitherto, compensation for the movement of an image I consisted in displacing the subfields of each pixel in a direction and a sense that are defined by the associated movement vector. All the subfields were displaced in the same sense, namely in the opposite sense to the movement vector, as in FIG. 4.

According to the invention, it is proposed to displace the subfields with respect to a reference subfield other than the subfield SF1 or the subfield SF9. Some of the subfields are then displaced in the sense of the movement vector calculated for the pixel in question and the other subfields are displaced in the opposite sense.

The method of the invention is illustrated by FIG. 5. The arrows shown as continuous lines represent, as in FIG. 4, the movement vectors associated with pixels of the video field of the image I that are representative of the movement between the images I−1 and I. According to the invention, a reference subfield, SF6 in the present case, for which the pixels of the image I will not be displaced, is defined. This is why, in FIG. 5, the video field of the image I is placed level with the subfield SF6 of the temporal integration window of the image I. Likewise, the video field of the image I−1 is placed level with the subfield SF6 of the temporal integration window of the image I−1.

According to the invention, for each pixel of the image I, the subfields following the reference subfield SF6, namely the subfields SF7 to SF9, are displaced in the sense of the movement vector associated with the pixel in question and the subfields preceding the reference subfield SF6, namely the subfields SF1 to SF5, are displaced in the opposite sense. In the end, the shift between the subfield SF1 and the subfield SF9 must be approximately equal to the amplitude of the movement vector. The amplitude of displacement of each subfield depends on the temporal position of the latter with respect to the reference subfield. The further temporally the subfields are from the reference subfield, the more they are spatially displaced.

In FIG. 5, two large arrows indicate the sense of displacement of the subfields. The rising large arrow indicates that the subfields SF1, SF2, SF3, SF4, and SF5 are displaced in the opposite direction to the movement vector and the downward large arrow indicates that the subfields SF7, SF8 and SF9 are shifted in the sense of the movement vector. Arrows shown as dotted lines extending the vectors representative of the movement between I−1 and I are shown in FIG. 5 in order to illustrate the displacement of the subfields SF7 to SF9.

The amplitude of displacement of a subfield with respect to the reference subfield is calculated according to its temporal position with respect to the reference subfield in the temporal integration window and to the amplitude of the movement vector in question.

Consider, for example, the case of a subfield SFn to be shifted. The temporal position of the centre of gravity of the subfield SFn denotes the temporal position of the middle of the sustain period of the subfield SFn. The difference between the temporal position of the centre of gravity of the subfield SFn and that of the reference subfield is, for example, M milliseconds. The duration of the temporal integration window is N milliseconds, where M<N. Let V=(Vx,Vy) be the movement vector to be taken into account for the displacement of the subfield SFn and let Δ=(Δ_{X}, Δ_{Y}) be the amplitude of displacement of the subfield SFn, then:

$${Δ}_{X} ( SFn ) = \frac{M}{N} * {V}_{X} and {Δ}_{Y} ( SFn ) = \frac{M}{N} * {V}_{Y} .$$

As shown in FIG. 5, this method allows the number of holes and conflicts in the temporal integration window to be reduced. The holes are now distributed in two smaller regions. The same applies to the conflicts.

Advantageously, a reference subfield near the middle of the temporal integration window was chosen so as to optimize the overall reduction in holes and conflicts. In our preferred illustrative example, the number of holes and conflicts is reduced by a factor of about two. The position of the reference subfield may vary depending on the distribution of the various illumination weights of the subfields. It goes without saying that the reference subfield may lie elsewhere than approximately in the middle of the said temporal integration window.

A variant consists in not taking a reference subfield but in taking only a reference instant located between two subfields. In this case, all the subfields are displaced. The preferred example uses a reference subfield as this makes it possible to avoid having to carry out displacement calculations for the said reference subfield.

Very many structures for implementing the method of the invention are possible. An illustrative example is shown in FIG. 6. An image memory 10 receives a stream of images to be stored. The size of the memory allows at least three images to be stored, the image I+1 being stored while the image I is being processed using the image I−1. A calculating circuit 11, for example a signal processor, calculates the movement vectors to be associated with the various images and shifts the subfields of the images according to the method described above and delivers the ignition signals to the line 12 and column 13 drivers of a plasma panel 14. A synchronization circuit 15 is designed to synchronize the drivers 12 and 13. This structure is given merely as an illustration.

1. Method of displaying video images on a plasma display panel comprising a plurality of elementary cells, in which the grey levels are obtained by temporal integration over a period called the temporal integration window comprising a plurality of subfields (SF1 to SF9) during which each elementary cell is either in the on state or in the off state, characterized in that it comprises the following steps:
for each video image (I) to be displayed, the movement of the video image to be displayed with respect to the previous video image (I−1) is estimated so as to generate a movement vector for each pixel of the video image to be displayed;
a reference instant placed within the temporal integration window is defined;
for each pixel of the video image to be displayed, the subfields are displaced with respect to the reference instant so that the shift between the first subfield (SF1) and the last subfield (SF9) is approximately equal to the amplitude of the associated movement vector, the amplitude of the displacement of each subfield depending on its temporal position with respect to the reference instant in the temporal integration window and on the direction of the associated movement vector.

2. Method according to claim 1, characterized in that a reference subfield (SF6) coincides with the reference instant, the reference subfield being different from the first subfield (SF1) or the last subfield (SF9) of the said plurality of subfields.

3. Method according to claim 1, characterized in that the subfields (SF7 to SF9) following the reference instant in the temporal integration window are displaced in the sense of the movement vector and the subfields (SF1 to SF5) preceding the reference instant in the temporal integration window are displaced in the opposite sense and in that the amplitude of displacement of the subfields is given by the following formulae:
$${Δ}_{X} ( SFn ) = \frac{M}{N} * {V}_{X} and {Δ}_{Y} ( SFn ) = \frac{M}{N} * {V}_{Y}$$
where:
SFn denotes the subfield to be displaced;
Δ_{X}(SFn) represents the displacement of the subfield SFn along the X-axis;
Δ_{Y}(SFn) represents the displacement of the subfield SFn along the Y-axis;
M represents the difference between the temporal position of the centre of gravity of the subfield SFn and the reference instant;
N represents the duration of the temporal integration window of a video image, where N>M; and
V_{X} and V_{Y} represent the components of the movement vector in question along the X-axis and along the Y-axis, respectively.

4. Method according to claim 2, characterized in that the reference subfield (SF6) is close to the middle of the temporal integration window.

5. Plasma display panel, characterized in that it includes a device for implementing the display method of one of claims 1 to 4.
